(19) United States
(12) Patent Application Publication
(10) Pub. No.: US 2007/0237701 A1
(43) Pub. Date: Oct. 11, 2007

(54) Silica Sol and Process for Producing Same

(76) Inventors: Yasuhiro Yamakawa, Chiba (JP); Yoshiaki Tomoda, Kyoto (JP); Keiji Toyama, Kyoto (JP); Masatoshi Sakai, Kyoto (JP)

Correspondence Address: Curt Harrington, Suite 250, 6300 State University Drive, Long beach, CA, 90815, US

(21) Appl. No.: 11/632,936

(22) PCT Filed: Jan. 18, 2005
(86) PCT No.: PCT/JP05/00551

§ 371 Date: Apr. 11, 2007

(30) Foreign Application Priority Data
Jul. 26, 2004 (JP) 2004-217655

(51) Int. Cl. C01B 33/141

(52) U.S. Cl. 423/335

(57) ABSTRACT

[PROBLEMS] To provide a silica sol and the method of producing the silica sol, wherein the silica sol is suitable for use as a material for, e.g., an abrasive material for electronic materials, silicon wafers or the like which are required to have a high purity, has excellent sol stability, can hence be easily made to have an increased silica concentration, and can be regulated so as to have a silica concentration equal to or higher than that of silica sols produced from water glass.

[MEANS FOR SOLVING PROBLEMS] The silica sol comprises water and fine silica particles dispersed therein, and wherein the fine silica particles have a secondary-particle diameter of 10-1,000 nm, a metal impurity content of 1 ppm or lower, and a silica concentration of 10-50 wt. %. Also provided is a process for producing a stable silica sol comprising the following steps (a) and (b). (a) A first step in which a hydrolyzable silicon compound is hydrolyzed and condensation-polymerized to produce a silica sol. (b) A second step in which the silica sol obtained in the first step is concentrated to a silica concentration not higher than a certain value according to the particle diameter, and the dispersion medium and alkali catalyst in the silica sol are replaced with water to regulate the pH to 6.0-9.0.

### BACKGROUND OF THE INVENTION

1. Technical Field

The present invention relates to silica sol and a method of producing the silica sol, its object is to provide a silica sol and the method of producing the same, wherein the silica sol is suitable for use as a material for, e.g., an abrasive material for electronic materials, silicon wafers or the like which are required to have a high purity, has excellent sol stability, can hence be easily made to have an increased silica concentration, and can be regulated so as to have a silica concentration equal to or higher than that of silica sols produced from water glass.

2. Description of the Related Art

Silica sol was conventionally made by using sodium silicate solution called water glass as starting material (see JP S61-158810). In this way, sodium silicate solution is treated with cation-exchange resin so that ions such as sodium ion in sodium silicate are removed in order to increase the purity of the starting material. Then, the resultant is used for producing silica sol.

However, because the above-method employs ion-exchange resin for making high purity, its purity is limited to some degree. Thus, it is extremely difficult to produce silica sol having 1 ppm or lower content of metal impurity such as alkali metal (e.g., sodium), copper, nickel and aluminium, thus, which satisfies requirement for using as electronic materials.

Alternately, as the method for producing silica sol having high purity, a method, wherein alkoxysilane having high purity such as tetraethoxysilane is hydrolyzed, is known. (see JP S63-74911 and JP H6-316407)

However, silica sol produced by the above-method wherein alkoxysilane is hydrolyzed has less preservation stability and difficulty in increasing silica concentration, because unreacted alkoxysilane is easy to remain in the obtained silica sol. This is especially true in the case of using tetraethoxysilane which is more slowly reacted than tetramethoxysilane is.

Silica sol obtained from hydrolysis of alkoxysilane has high purity and hence has less counter ion, and such silica sol is therefore less stable. Thus the silica sol induces its viscosity rise and acceleration of gelatinization as the silica concentration is increased. As a result, it is difficult to increase a silica concentration, thus silica sol obtained from hydrolysis of alkoxysilane is economically inefficient because such silica sol generally has less silica concentration than the one obtained from water glass.

### SUMMARY OF THE INVENTION

### Problem to be Solved by the Invention

The object of the present invention is to provide a silica sol obtained from hydrolysis of alkoxysilane and the method of the silica sol, wherein the silica sol has excellent sol stability, can hence be easily made to have an increased silica concentration, and can be regulated so as to have a silica concentration equal to or higher than that of silica sols produced from water glass, and further have 1 ppm or lower content of metal impurity such as sodium wherein the content of metal impurity has to be achieved when it is used for electronic materials.

### The Means of Solving the Problems

The present invention was made for solving the above-problems. The present inventions provides a method of producing a stable silica sol comprising; (a) hydrolyzing and condensation-polymerizing a hydrolyzable silicon compound to produce a silica sol, and (b) concentrating the silica sol obtained from the step (a) to a silica concentration not higher than a certain value according to the particle diameter, and replacing the dispersion medium and alkali catalyst in the silica sol with water to regulate pH to 6.0-9.0.

According to one embodiment of the present invention, the method further comprises the step of concentrating the stable silica sol replaced with water, which is obtained from the method of claim 1, after or during regulating pH to 7 or more by adding alkali to the stable silica sol.

According to one embodiment of the present invention, the alkali is ammonia.

According to one embodiment of the present invention, the hydrolyzable silicon compound is Tetramethoxysilane.

According to one embodiment of the present invention, the dispersion medium in the silica sol obtained in the step (a) is methanol.

The present inventions further provides a silica sol comprising water and fine silica particles dispersed therein, wherein t the fine silica particles have an average secondary-particle diameter of 10-1,000 nm, a metal impurity content of 1 ppm or lower, and a silica concentration of 10-50 wt. %, wherein the average secondary-particle diameter is 1.5-3.0 times as large as an average primary-particle diameter.

### Effects of the Invention

According to the methods of some embodiment of the present invention, silica sol having excellent sol stability and long-term preservation stability, wherein the silica sol has less viscosity rise and less acceleration of gelatinization when the silica concentration is increased, is made.

The method according to one embodiment of the present invention employs ammonia as alkaline catalyst. The ammonia is easy to be removed because of its high volatility, and therefore pH of the silica sol is maintained in neutrality.

The method according to one embodiment of the present invention employs tetramethoxysilan as hydrolyzable silicon compound. Because the tetramethoxysilan is more rapidly reacted than the other silicon compounds and prevents its residue from remaining in the sol, it is easy to obtain the silica sol having high productivity and stability.

The method according to one embodiment of the present invention employs methanol as the dispersion medium. In this way, methanol may be the same alcohol as the one generated from hydrolysis of hydrolyzable silicon compound. Thus, the method is economically efficient because medium is easily recovered and reused.

The silica sol according to one embodiment of the present invention has excellent sol stability, can hence be easily made to have an increased silica concentration, and can be regulated so as to have a silica concentration equal to or higher than that of silica sols produced from water glass.

### BRIEF DESCRIPTION OF THE DRAWINGS

FIG. 1 is the chart showing correlation between pH of the silica sol obtained from the example 1 and the secondary-particle diameter.

### DESCRIPTION OF THE PREFERRED EMBODIMENTS

The silica sol and the method of producing the silica sol according to the present invention will be described in detail as below.

The method according to the present invention comprises (a) hydrolyzing and condensation-polymerizing a hydrolyzable silicon compound to produce a silica sol and (b) concentrating the silica sol obtained from the step (a) to a silica concentration not higher than a certain value according to the particle diameter, and replacing the dispersion medium and alkali catalyst in the silica sol with water to regulate the pH to 6.0-9.0, preferably to 7.0-8.0

The present invention may further comprises a step concentrating the stable silica sol replaced with water, which is obtained from the step (a) and (b), after or during regulating pH to 7 or more by adding alkali to the stable silica sol replaced with water.

The first step comprised in the method of producing a silica sol according to the present invention is the step (a) hydrolyzing and condensation-polymerizing a hydrolyzable silicon compound to produce a silica sol.

Any method for hydrolyzing and condensation-polymerizing a hydrolyzable silicon compound to produce a silica sol may be adopted. For example, the silica sol may be prepared by sol-gel process with hydrolyzable silicon compound (hereinafter referred to as silicon compound).

The sol-gel process is the process, in which solution containing metal organic compound is used as a starting material, the compound in the solution is hydrolyzed and condensation-polymerized to make sol comprising fine particles of metal oxide or metal hydroxide dissolved therein, and gelatinization is accelerated by further reaction in order to obtain an amorphous sol. For example, silicon compound may be hydrolyzed and condensation-polymerized in solvent medium in the presence of water.

The silicon compound may be, for example, tetramethoxysilan, tetraethoxysilan, tetrapropoxysilan, tetra-iso-propoxysilan or the like.

Low-condensation compound which is produced by partly hydrolyzing the silicon compound may be used as the silicon compound. The silicon compounds may be used as single agent, and alternately two or more silicon compounds may be used in combination. According to the present invention, tetramethoxysilan is preferably used. This is because tetramethoxysilan is rapidly hydrolyzed and prevents its residue from remaining in the sol, and it is easy to obtain the silica sol having high productivity and stability.

The silicon compound is hydrolyzed and condensation-polymerized in aqueous solvent medium to produce silica sol. The medium used in the present invention may be alcohol such as methanol, ethanol, n-propanol, isopropanol, ethylene glycol, propylene glycol, 1,4-butanediol or the like; ketone such as acetone, methyl ethyl ketone or the like; ester such as acetic ester or the like.

Among the above-mediums, alcohol is preferably used in the present invention, and methanol, ethanol and isopropanol are especially preferable.

This is because such mediums are easy to be replaced with water by heating distillation in succeeding step replacing with water. The replacement step will be described later.

In more detail, it is more preferable to use alcohol as the medium, which is the same kind as the alcohol generated from hydrolysis of the silicon compound. Using alcohol which is the same kind as the alcohol generated from hydrolysis of the silicon compound facilitates recovery and reuse of the medium.

The medium may be used individually, and alternately two or more kinds of medium may be used in combination.

Amount of the medium to be used is not limited, but may be 5-50 mol per 1 mol of raw material to be used.

This is because the medium is hardly compatible with the silicon compound which is used as the raw material when it is used in amount under 5 mol per the raw material, and because the amount of the medium which is more than 50 mol per the raw material is inefficient in producing.

Amount of water to be used is not limited to, but may be 2-15 mol per 1 mol of raw material to be used.

Particle diameter of fine silica particle to be formed depends on the amount of the water.

Relatively-increased amount of the water makes the particle diameter of fine silica particle large. Relatively-decreased amount of the water alternatively makes the particle diameter of fine silica particle small.

Therefore, the particle diameter of fine silica particle may optionally be regulated by adjusting ratio in amount between the water and medium.

Alkali catalyst may be added to the medium.

Any known alkali catalysts may be used in the present invention. For example, diaminoethane, diethylenetriamine, triethylenetetraamine, ammonia, carbamide, ethanolamine, tetramethyl ammonium hydroxide or the like may be used in order to avoid incorporation of metal impurity. According to the present invention, it is preferable to use ammonia. This is because it has excellent catalytic activity and high volatility, and is easily-removable in succeeding steps.

When using the alkali catalyst, amount of the alkali catalyst is not limited, but may be 0.05-2 mol per 1 mol of the raw material to be used. pH of the reaction-medium is regulated preferably to pH 8-11, more preferably to pH 8.5-10.5 by adding the alkali catalyst. Optionally, uniform micelle may be formed by adding detergent when the organic solvent medium, water and catalyst are not compatible.

In order to hydrolyze and condensation-polymerize the silicon compound in the aqueous solvent medium, the silicon compound is added to the aqueous solvent medium, and it is stirred at preferably 0-100 Celsius degree (° C.), more preferably 0-70° C. As just described, by hydrolyzing and condensation-polymerizing the raw material in the aqueous solvent medium with stirring it, silica sol having fine silica particles is produced wherein the fine silica particles is spherical and uniformly sized.

In the method of producing a stable silica sol according to the present invention, the second step is (b) concentrating the silica sol obtained in the step (a) to a silica concentration not higher than a certain value according to the particle diameter, and replacing the dispersion medium and alkali catalyst in the silica sol with water to regulate the pH to 6.0-9.0, preferably to 7.0-8.0.

Any method for concentrating the silica sol obtained in the step (a) and replacing with water may be adopted. For example, the method may be adopted, in which the silica sol is concentrated and replaced with water by heating distillation with dropping silica sol or water while maintaining silica sol volume.

In this way, the replacement is preferably performed until temperature of the top of the column and temperature of liquid therein reaches to the boiling temperature of water to be replaced with.

Unless the replacement is performed under the condition of silica concentration not higher than a certain value, viscosity and aggregation caused by unreacted materials is accelerated, and finally sedimentary gel is generated.

Further, the replacement is performed until pH of the silica sol reaches to neutral range of pH 6.0-9.0, preferably of pH 7.0-8.0.

pH of the silica sol is regulated to neutral range by replacing the dispersion medium and alkali catalyst in the silica sol with water, and the silica sol having long-term preservation stability is obtained by removing unreacted materials included in the silica sol.

Water used in this step may preferably be pure water or extrapure water. Such water avoids incorporation of metal impurity.

Concentration of the concentrated silica may be 60 wt. % or lower, preferably 50 wt. % or lower, further preferably 40 wt. % or lower.

Although minimal value of the concentration affecting on its quality does not exist, high concentration is relatively effective for its productivity.

The higher concentration of the concentrated silica causes increase of agglomerates and high viscosity which causes less operability and workability.

Correlation between the silica particle diameter and concentration of the concentrated silica is described as below.

1) In the case that X of the silica sol obtained from the first step indicates the value from 5.0 to less than 7.5.
Y1=6X−12.5, Y2=6X−15

2) In the case that X of the silica sol obtained from the first step indicates the value from 7.5 to 35.
Y1=0.6X+28, Y2=0.45X+27

X: Index of particle diameter calculated by [(primary-particle diameter)*(primary-particle diameter)/(secondary-particle diameter)]

Y1: Concentration (%) of the concentrated silica according to the index of particle diameter.

Y2: more preferable concentration (%) of the concentrated silica according to the index of particle diameter.

The method of producing silica sol having high silica concentration according to the present invention comprises the step of concentrating the stable silica sol replaced with water, which is obtained from the second step, after or during regulating pH to 7 or more by adding alkali to the stable silica sol.

Any method for regulating pH to 7 or more may be adopted. For example, pH of the silica sol may be regulated to alkaline during the addition of alkali to the silica sol.

Alkali to be added to silica sol may for example be diaminoethane, diethylenetriamine, triethylenetetramine, ammonia, carbamide, ethanolamine, tetramethyl ammonium hydroxide, alkali metal salt, alkaline earth metal salt or the like, but not limited to these.

The alkali metal salt may be lithium, sodium, potassium, rubidium, cesium, francium.

The alkaline earth metal salt may be beryllium, calcium, magnesium, strontium, barium, radium.

According to the present invention, it is preferable to use ammonia. This is because it has high volatility, and is easily-removable in succeeding steps.

Methods for concentrating the stable silica sol having pH 7 or more are not particularly limited, and any conventional methods for concentrating the silica sol may be adopted. For example, process of heating concentration, membrane concentration or the like may be used.

According to the process of heating concentration, silica sol may be heating-concentrated under normal pressure or vacuum pressure.

When adopting the process of membrane concentration, membrane separation is preferably carried out according to ultrafiltration process in which fine silica particles are filtrated.

Fractional molecular of the ultrafilter membrane needs to be determined according to particle diameter of particles to be generated, but is not limited to this.

Materials composing ultrafiltration membrane may be polysulfone, polyacrylonitrile, sintered metal, ceramic, carbon or the like, but are not limited to. these Form of ultrafiltration membrane may be spiral, tubular and hollow fiber form or the like, but are not limited to these.

Operation pressure may be adjusted to the same or less pressure as the working pressure of ultrafiltration membrane, but are not limited to these.

According to the present invention, if necessary, silica gel replaced with water, which is obtained from the second step, may be preliminarily concentrated to degree in which viscosity does not start to be raised and in which gelatinization does not start to be accelerated. After the preliminary concentration, alkali may be added for further concentration.

According to the method of producing silica sol having high silica concentration, excellently stable silica sol having high silica concentration is produced without aggregation and gelatinization of the fine silica particle, even if the silica concentration is increased. This is because the silica sol is concentrated by medium-replacement or the like during regulating pH to alkaline after impurity (e.g., unreacted material) contained in the silica sol is removed.

Silica sol produced by production-method described above comprising fine silica particles having spherical shape with uniform size and an average secondary-particle diameter of 10-1000 nm, preferably 20-300 nm.

A metal impurity content of the silica sol having high silica concentration according to the present invention is 1 ppm or lower, wherein said metal impurity content means total amount of metal impurity such as Al, Ca, B, Ba, Co, Cr, Cu, Fe, Mg, Mn, Na, Ni, Pb, Sr, Ti, Zn, Zr, U, Th or the like.

A silica concentration of the silica sol having high silica concentration according to the present invention is 10-50 wt. %, preferably 30-50 wt. %, and pH of the silica sol is pH 6.0-9.0, preferably pH 7.0-8.0.

As to the fine silica particle contained in the silica sol having high silica concentration according to the present invention, an average secondary-particle diameter is equal to or less the value which is three times as large as the average primary-particle diameter or, preferably 1.5-2.5 times as large as an average primary-particle diameter under the condition of high concentration of the silica. Because such fine silica particles are hardly aggregated and gelatinized, the silica sol having high silica concentration according to the present invention has excellent long-term preservation stability.

### EXAMPLE

The examples of the present inventions will be described according to the examples 1-7 and comparative examples 1-7 in more detail as below. It should be understood, however, that the present invention is not limited by these examples.

(Reaction Process)

Pure water, 26% of aqueous ammonia and methanol were mixed to obtain mixture liquid (hereinafter referred to as base liquid I.)

In examples 1-7 and comparative examples 1-7, amounts (wt. %) of the pure water in base liquid I were all regulated to 15 wt. %.

Amounts (wt. %) of the ammonia in the base liquid I were regulated to 0.6 wt. % to prepare the examples 1-5 and comparative examples 1-5, and to 1.0 wt. % to prepare the example 6 and comparative example 6, and further to 2.0 wt. % to prepare the example 7 and comparative example 7.

Tetramethoxysilane and methanol were mixed to obtain mixture liquid (hereinafter referred to as base liquid II.) The base liquid II was poured into the base liquid I at a constant speed, keeping the liquid temperature being 20° C. to obtain silica sol.

As to composition of base liquid II, Tetramethoxysilane and methanol were mixed by volume ratio of 3:1. Base liquid I and base liquid II were used by volume ratio of 9:1.

(Concentration Process 1)

The silica gel obtained from the process 1 was concentrated to a certain value with heating distillation.

Silica concentrations (%) of the concentrated silica gel were regulated to 15% for the examples 1-5 and comparative examples 3-5.

For the others, in order to make alternated condition, the examples 6 and 7 were regulated to 28% and 38 % respectively, the comparative examples 1 and 2 were regulated to 22% and 25% respectively, and the comparative examples 6 and 7 were regulated to 40% and 53% respectively. The table 1 shows those results.

(Replacement With Water Process)

Pure water was dropped into the liquid produced by the above-concentration process in order to replace methanol and ammonia in the concentrated liquid with water by heating distillation. This replacement was performed while its volume was kept equivalent or more volume of the liquid.

For the comparative example 4, acetic acid was added to the liquid during replacement with water in order to acidify it.

The table 1 shows pH of each example replaced with water.

TABLE 1

| | | | Reaction condition | | | |
|---|---|---|---|---|---|---|
| | Liquid I composition | | | Pouring | Concentration 1 | |
| | NH₃ | H₂0 | Temperature | time of | Silica | Replacement |
| | concentration | concentration | of reaction | liquid I | concentration at | with water |
| | (wt. %) | (Wt. %) | (° C.) | (min) | the end (%) | pH at the end |
| Example 1 | 0.6 | 15 | 20 | 30 | 15 | 7.4 |
| Example 2 | 0.6 | 15 | 20 | 30 | 15 | 8.5 |
| Example 3 | 0.6 | 15 | 20 | 30 | 15 | 6.8 |
| Example 4 | 0.6 | 15 | 20 | 30 | 15 | 7.5 |
| Example 5 | 0.6 | 15 | 20 | 30 | 15 | 7.5 |
| Comparative | 0.6 | 15 | 20 | 30 | 22 | 7.4 |
| Example 1 | | | | | | |
| Comparative | 0.6 | 15 | 20 | 30 | 25 | 7.5 |
| Example 2 | | | | | | |
| Comparative | 0.6 | 15 | 20 | 30 | 15 | 9.6 |
| Example 3 | | | | | | |
| Comparative | 0.6 | 15 | 20 | 30 | 15 | 5.3 |
| Example 4 | | | | | | |
| Comparative | 0.6 | 15 | 20 | 30 | 15 | 7.4 |
| Example 5 | | | | | | |
| Example 6 | 1.0 | 15 | 20 | 30 | 28 | 7.5 |
| Comparative | 1.0 | 15 | 20 | 30 | 40 | 7.5 |
| Example 6 | | | | | | |
| Example 7 | 2.0 | 15 | 20 | 30 | 38 | 7.6 |
| Comparative | 2.0 | 15 | 20 | 30 | 53 | 7.5 |
| Example 7 | | | | | | |

(Concentration Process 2)

All examples except the examples 4 and 5 were concentrated by distillation with normal pressures.

The example 4 was concentrated by distillation with vacuum pressure, and the example 5 was concentrated by filtration with ultrafilter membrane whose fractional molecular is 50000.

26% of aqueous ammonia was added to liquid replaced with water, which is described above, during the concentration in order to regulate pH to 7.0-10.0.

pH of the comparative example 5 was not regulated.

The silica sol was obtained by the above-concentration process wherein the final silica concentrations (%) thereof were regulated to 35% for the examples 1-5 and the comparative examples 1-5, to 40% for the example 6 and the comparative example 6, and to 45% for the example 7 and comparative example 7.

(Test Example 1; Measurement of Physical Properties)

The primary-particle diameter, the secondary-particle diameter, pH, a silica concentration and metal impurity content concentration were measured on the fine silica particles in the silica sol having high silica concentration of the examples 1-7 and the comparative examples 1-7 prepared by the above-described processes. Those results are shown in the tables 2 to 5.

The primary-particle diameter was calculated from the following formula 1 (formula 1).

The secondary-particle diameter was measured with photon correlation method.

The silica concentration (%) was derived from the amount of the residue obtained from exsiccation of the silica sol followed by igniting at 800° C.

(Formula 1)

The primary-particle diameter (nm)=2727/BET specific surface area (m²/g)

TABLE 2

| | Example 1 | Example 2 | Example 6 | Example 7 |
|---|---|---|---|---|
| The primary-particle diameter | 14 | 14 | 38 | 110 |
| (treated) (nm) | | | | |
| the secondary-particle diameter | 38 | 38 | 80 | 170 |
| (treated) (nm) | | | | |
| Silica concentration (treated) | 35 | 35 | 40 | 45 |
| (wt. %) | | | | |
| pH | 7.5 | 7.7 | 7.5 | 7.7 |
| Na (ppm) | 0.1 or less | 0.1 or less | 0.1 or less | 0.1 or less |
| K (ppm) | 0.1 or less | 0.1 or less | 0.1 or less | 0.1 or less |
| Fe (ppm) | 0.1 or less | 0.1 or less | 0.1 or less | 0.1 or less |
| Al (ppm) | 0.1 or less | 0.1 or less | 0.1 or less | 0.1 or less |
| Ca (ppm) | 0.1 or less | 0.1 or less | 0.1 or less | 0.1 or less |
| Mg (ppm) | 0.1 or less | 0.1 or less | 0.1 or less | 0.1 or less |
| Ti (ppm) | 0.1 or less | 0.1 or less | 0.1 or less | 0.1 or less |
| Zn (ppm) | 0.1 or less | 0.1 or less | 0.1 or less | 0.1 or less |
| Ni (ppm) | 0.01 or less | 0.01 or less | 0.01 or less | 0.01 or less |
| Cr (ppm) | 0.01 or less | 0.01 or less | 0.01 or less | 0.01 or less |
| Cu (ppm) | 0.01 or less | 0.01 or less | 0.01 or less | 0.01 or less |
| Pb (ppm) | 0.01 or less | 0.01 or less | 0.01 or less | 0.01 or less |

TABLE 3

| | Example 3 | Example 4 | Example 5 |
|---|---|---|---|
| The primary-particle | 14 | 14 | 14 |
| diameter (treated) (nm) | | | |
| the secondary-particle | 37 | 38 | 37 |
| diameter (treated) (nm) | | | |
| Silica concentration | 35 | 35 | 35 |
| (treated) (wt. %) | | | |
| pH | 7.4 | 7.4 | 7.6 |

TABLE 4

| | Comparative | Comparative | Comparative | Comparative |
|---|---|---|---|---|
| | Example 1 | Example 2 | Example 3 | Example 4 |
| The primary-particle diameter | 15 | * | 14 | * |
| (treated) (nm) | | | | |
| the secondary-particle diameter | 62 | * | 49 | * |
| (treated) (nm) | | | | |
| Silica concentration (treated) | 35 | 35 | 35 | 35 |
| (wt. %) | | | | |
| pH | 7.5 | 7.6 | 7.5 | 7.4 |

*Much amount of agglomerate sediments was generated.

TABLE 5

| | comparative | comparative | comparative |
|---|---|---|---|
| | Example 5 | Example 6 | Example 7 |
| The primary-particle | 14 | * | * |
| diameter (treated) (nm) | | | |
| the secondary-particle | 58 | * | * |
| diameter (treated) (nm) | | | |
| Silica concentration | 35 | 40 | 45 |
| (treated) (wt. %) | | | |
| pH | 6.7 | 7.4 | 7.8 |

*Much amount of agglomerate sediments was generated.

The table 2 and table 3 shows the each sample of the examples 1-7 had no noticeable agglomerates after the concentration.

In contrast, the table 4 and table 5 shows agglomerates of the fine silica particles were generated in the sample of the comparative examples.

(Test Example 2; Change of the Secondary-particle Diameter According to Shift of pH)

Change of the secondary-particle diameter according to shift of pH was confirmed by the following. Pure water was dropped into silica sol having 35% of silica concentration obtained from the example 1 wherein the silica sol was treated with heating-distillation at normal pressure. The volume thereof was maintained during the dropping.

The shows the results.

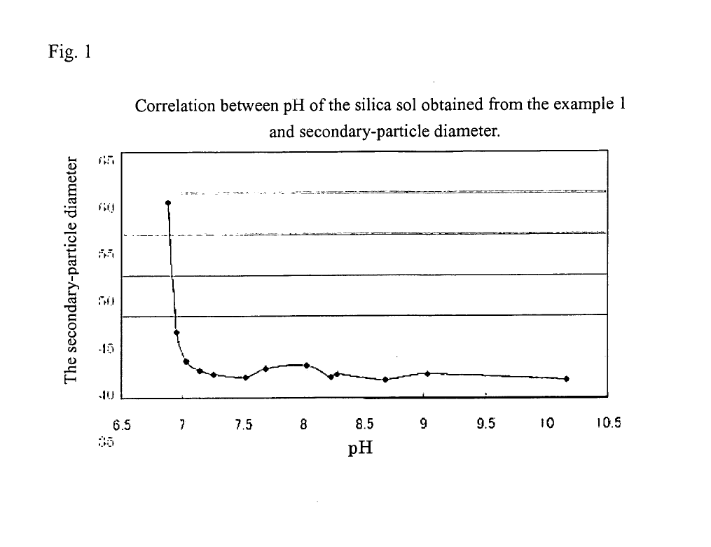

It is confirmed from the chart of FIG. 1 that the secondary-particle diameter is increased when pH of the silica sol is 7.0 or less, it is not changed when pH of the silica sol is 7.0 or more.

The above-result shows the fine silica particles are less stable and easily subject to aggregation when the silica sol is ranged within around neutrality indicating pH 7 or less. Contrastively, when silica sol is ranged from around neutrality to around alkaline silica sol indicating pH 7.0 or more, the fine silica particles thereof are excellently stable and hardly subject to aggregation.

1. A method of producing a stable silica sol having high silica concentration comprising;
(a) hydrolyzing and condensation-polymerizing a hydrolyzable silicon compound to produce a silica sol,
(b) concentrating the silica sol obtained from the step (a) to a silica concentration not higher than a certain value according to the particle diameter, and replacing the dispersion medium and alkali catalyst in the silica sol with water to regulate pH to 6.0-9.0, and
(c) concentrating the stable silica sol replaced with water, which is obtained from the step (b), after or during regulating pH to 7 or more by adding alkali to the stable silica sol.

2. The method of producing silica sol described in claim 1, wherein the alkali is ammonia.

3. The method of producing silica sol described in claim 1, wherein the hydrolyzable silicon compound is Tetramethoxysilane.

4. The method of producing silica sol described in claim 1, wherein the dispersion medium in the silica sol obtained in the step (a) is methanol.

5. A silica sol comprising water and fine silica particles dispersed therein, wherein the fine silica particles have a secondary-particle diameter of 10-1,000 nm, a metal impurity content of 1 ppm or lower, a silica concentration of 30-50 wt. % and pH 7.0-10.0, wherein the average secondary-particle diameter is 1.5-3.0 times as large as an average primary-particle diameter.

6. The method of producing silica sol described in claim 1, wherein the alkali is ammonia, and wherein the hydrolyzable silicon compound is Tetramethoxysilane.

7. The method of producing silica sol described in claim 1, wherein the alkali is ammonia, and wherein the dispersion medium in the silica sol obtained in the step (a) is methanol.

8. The method of producing silica sol described in claim 1, wherein the hydrolyzable silicon compound is Tetramethoxysilane, and wherein the dispersion medium in the silica sol obtained in the step (a) is methanol.

9. The method of producing silica sol described in claim 1, wherein the alkali is ammonia, wherein the hydrolyzable silicon compound is Tetramethoxysilane, and wherein the dispersion medium in the silica sol obtained in the step (a) is methanol.
